(19) United States
(12) Patent Application Publication
(10) Pub. No.: US 2009/0144808 A1
(43) Pub. Date: Jun. 4, 2009

(54) Collaborative Learning Space Portal

(76) Inventor: Sudhanva Dhananjaya, Mysore (IN)

Correspondence Address: CENTRAL COAST PATENT AGENCY, INC, 3 HANGAR WAY SUITE D, WATSONVILLE, CA, 95076, US

(21) Appl. No.: 12/196,691

(22) Filed: Aug. 22, 2008

(30) Foreign Application Priority Data
Dec. 4, 2007 (IN) 2893/CHE/2007

(51) Int. Cl. H04L 9/32

(52) U.S. Cl. 726/4

(57) ABSTRACT

The embodiments of present invention provide a method of providing online community portal to improve communication and collaboration among authorized users of a wide range of learning communities of the portal and further presenting and sharing the information from diverse sources in a unified way. Collaborative learning space is created by authorized user based on the preference and administrative privileges provided to user and metadata is attached to the learning space. Users with similar profiles are invited the learning space through automatic pattern match and search. The authorized user of the learning space can interact, communicate, and collaborate, co-ordination and share the knowledge and data with other users of the learning space.

### BACKGROUND

1. Technical Field

The embodiments herein generally relate to online communication portal and more specifically relates to web-based online learning portal designed to improve communication and collaboration among learners, customers, partners, and employees or in general, a wide range of learning communities.

2. Description of the Related Art

The World Wide Web search engines have fundamentally transformed the way people share information. A new form of publishing and sharing information through online networking has become very popular. Web based networking portals and search engines have provided a more personalized, context-based, and interactive platform to publish, share and search information more efficiently as compared to literature or formal document search. In the pre-internet era information was localized and people were dependent on local and personal interactions among their trusted personal network. In today's internet era any and every information is just a mouse click away. Online web based networks have evolved as very effective tool for people to interact, communicate and share information among each other.

The online web based network system allows users to share information among their personal and professional network. Generic web portals, social networks, search engines generally lack information that is relevant in a context to the user who wants to use them. Many times user needs a personalized, on time, valuable, and trusted input on the subject he or she is querying or searching for. The inputs from the networks and search engines are huge but the relevance to the current context is much to be desired.

People today want to share and contribute more and more information among the online communities they are part of. They want to have simpler and global reach. People today want a platform that presents information from diverse sources in a unified way and improvises communication and collaboration among learners, customers, partners, and employees or in general, a wide range of learning communities.

An online learning community remains one of the most popular concepts for technology-based learning in education. Teammates communicate with each other, learning together, searching for resources, supporting each other, conducting team projects online. Collaborative learning is frequently misunderstood as simply doing team projects working, working in teams, sharing project responsibilities, etc. Simply assigning learners a team projects and establishing a team for a limited period provides a less then ideal learning experience. Ideal collaboration involves learning in active participation in multiple tasks throughout the entire learning process inside and outside of the class. A learning community is often developed through this increased interaction.

The portal gathers relevant information and knowledge based on the individual member's inquiry and presents the result in a customized format. The function of the portal technology is to enable the community members as the center of his/her own learning. Usually different groups of users or participants are integrated into the collaborative community. A portal not only indicates the unified access, but also delivers the personalization after an appropriate authentication.

The idea of learning communities is featured prominently in many educational contexts. In schools and colleges it is a focus for discussion about the educational process and it is supported by research on how teaching and learning are best facilitated. The content creation by students, in a blog should be independent of single teacher or course. The students should have the opportunity to create a learning space that will function for the life of their stay at school, and even beyond. The learning space helps in moving beyond a course management system and rethink how learning can be supported by such a space.

Web blog truly expand the walls of the classroom. The internet has always provided the possibility of connecting students with others outside the class rooms via emails and chat groups. But now that collaboration can be much more accessible and much more diverse. We can create sites where classes from different geographies can conduct all sorts of experiments; share the results through text; picture, audio or video; and invite expert scientists in the process to reflect the result. And in a world that is moving more and more towards a business world.

The traditional approach to e-learning has been to employ the use of a Virtual Learning Environment (VLE). In contrast, e-learning 2.0 combines the use of discrete but complementary tools and web services—such as blogs, wikis, and other social software—to support the creation of ad-hoc learning communities. E-learning has the potential to become far more personal, social and flexible.

Existing online e-learning platforms are based on generic discussion forums. Most of e-learning systems provide collaboration of users with diversified background, different interests and objectives. They do not facilitate platform to presents information from diverse sources in a unified way. Also existing platforms do not provide comprehensive methodology for communication among the users with similar interests and storing/collecting the information/communication/content in a unified way.

Hence there is need to develop a method for providing online learning community portal to improve communication and collaboration among authorized users of a wide range of learning communities of the portal and further presenting and sharing the information from diverse sources in a unified way.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concept of the invention in a simplified form as a prelude to the more detailed description that is presented later.

The embodiments of present invention provide a method of providing online community portal to improve communication and collaboration among authorized users of a wide range of learning communities of the portal and further presenting and sharing the information from diverse sources in a unified way. The method comprising: a) collecting and storing information about authorized user of the community portal in form of metadata; b) creating collaborative learning space by the authorized user based on the preference and administrative privileges provided to the user; c) providing the compendium of Web tools such as Blog, Wiki, RSS Feeds, discussion forum, Podcast and other collaboration tools for the learning space; d) using metadata to invite similar profile users to the learning space through automatic pattern match and search. The pattern match and search is conducted between metadata of the learning space and metadata of the authorized users; and e) building information space by contributing contents, posting views/queries and comments, rating artifacts, subscribing news and audio/video materials in the learning space by user's of said learning space. Each user's privileges are decided by creator of the learning space.

The learning space is information space for communication and collaboration among users with compatible profiles for the learning space. The authorized user of the learning space can interact, communicate, and collaborate, co-ordination and share the knowledge and data with other users of the learning space. The pattern match and search can be conducted automatically or manually. The owner of the learning space provides search criteria for the manual pattern match and search. The creator of the learning space becomes owner of learning space. The owner of the learning space can upload and share documents with other users of the learning space. The user of the learning space can upload and share documents with other users of the learning space based on privileges provided to the user by the owner of the learning space.

According to an embodiment of the invention, the learning space can be content based learning space. The content based learning space is created based on specific content uploaded on the learning space by the owner and further discussions on the same. The owner of the content based learning space has the authority to invite similar profile users to the learning space based on the pattern match and search option.

According to another embodiment of the invention, the learning space can be open learning space. Any authorized user of the community portal can join the open learning space. The open learning space can be created for any general topic/subject/process.

According to another embodiment of the invention, the learning space can be profile based learning space. The profile based learning space is created based on specific topic/subject/process. Owner of the profile based learning space has the authority to invite similar profile users to the learning space based on the pattern match and search option. The owner of learning space provides metadata related to the learning space such topic in scope, topic out of scope, prerequisites, learning objectives, prior learning, skills, preference, age range, country, educational level, other keywords.

Another feature of the invention is learner ranking which is used to rank the users of the learning space. The user gains some points based on predefined formula whenever the user adds some value to the learning space by creating an artifact inform of blog, wiki, discussion forum topic; by contributing to any blog post, Wiki, discussions of the learning space, tagging metadata to any artifact or asset of the learning space. The learner ranking feature helps to identify the learning space top rankers and artifacts based on the contribution and rating received and further provides other users of the learning space an opportunity to interact with top rankers and get a chance to improve their understanding of the learning space topics. Based on the contribution on artifacts and assets by the users of the learning space, ranking of the artifacts and assets ranking increases.

The authorized users of community portal can view their learning spaces network they are linked with, their friends network they are connected with, the past activities and contributions in the learning spaces and their ranking progress. The owner of the learning space can add tools such as blog, Wiki, RSS, Podcast, discussion forum and other available collaboration tools available in the community portal. The metadata provided by said authorized user of community portal can be organization, role, name, email, date of birth, gender, address, country, state, city, contact number, interest, education, competencies, and keywords.

The users of the learning space can create/contribute on blogs by posting information or opinion, comments, viewing and rating. The users of the learning space can create/contribute on Wiki pages by editing contents or watching the content development. The users of the learning space can subscribe RSS feeds and get updated information instantly. The users of the learning space can subscribe Podcast of audio/video materials related to course contents or any interested topics. The users of the learning space can participate in discussion forum by posting topics, replies and rating topics/replies. The users of the learning space can collaborate with the other learning Space members using collaboration tools such as text chat, audio/video conferencing, whiteboard and presentation.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 shows three types of learning spaces and associated environment.

FIG. 2 illustrates flowchart for creation of learning space.

FIG. 3 shows WEB 2.0 tools associated with a leaning space.

FIG. 4 shows flowchart of search engine functionalities.

FIG. 5 illustrates ranking engine modules.

Although specific features of the present invention are shown in some drawings and not in others. This is done for convenience only as each feature may be combined with any or all of the other features in accordance with the present invention.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments of present invention provide a method of providing online community portal to improve communication and collaboration among authorized users of a wide range of learning communities of the portal and further presenting and sharing the information from diverse sources in a unified way. The method comprising: a) collecting and storing information about authorized user of the community portal in form of metadata; b) creating collaborative learning space by the authorized user based on the preference and administrative privileges provided to the user; c) providing the compendium of Web tools such as Blog, Wiki, RSS Feeds, discussion forum, Podcast and other collaboration tools for said learning space; d) using metadata to invite similar profile users to the learning space through automatic pattern match and search. The pattern match and search is conducted between metadata of the learning space and metadata of the authorized users; and e) building information space by contributing contents, posting views/queries and comments, rating artifacts, subscribing news and audio/video materials in the said learning space by user's of said learning space; wherein each user's privileges are decided by creator of the learning space.

The learning space is information space for communication and collaboration among users with compatible profiles for the learning space. The authorized user of the learning space can interact, communicate, and collaborate, co-ordination and share the knowledge and data with other users of the learning space. The pattern match and search can be conducted automatically or manually. The owner of the learning space provides search criteria for the manual pattern match and search. The creator of the learning space becomes owner of learning space. The owner of the learning space can upload and share documents with other users of the learning space. The user of the learning space can upload and share documents with other users of the learning space based on privileges provided to the user by the owner of said learning space.

According to an embodiment of the invention, the learning space can be content based learning space. The content based learning space is created based on specific content uploaded on the learning space by the owner and further discussions on the same. The owner of the content based learning space has the authority to invite similar profile users to the learning space based on the pattern match and search option.

According to another embodiment of the invention, the learning space can be open learning space. Any authorized user of the community portal can join the open learning space. The open learning space can be created for any general topic/subject/process.

According to another embodiment of the invention, the learning space can be profile based learning space. The profile based learning space is created based on specific topic/subject/process. Owner of the profile based learning space has the authority to invite similar profile users to the learning space based on the pattern match and search option. The owner of learning space provides metadata related to the learning space such topic in scope, topic out of scope, prerequisites, learning objectives, prior learning, skills, preference, age range, country, educational level, other keywords.

Another feature of the invention is learner ranking which is used to rank the users of the learning space. The user gains some points based on predefined formula whenever the user adds some value to the learning space by creating an artifact inform of blog, wiki, discussion forum topic; by contributing to any blog post, Wiki, discussions of the learning space, tagging metadata to any artifact or asset of the learning space. The learner ranking feature helps to identify the learning space top rankers and artifacts based on the contribution and rating received and further provides other users of the learning space an opportunity to interact with top rankers and get a chance to improve their understanding of the learning space topics. Based on the contribution on artifacts and assets by the users of the learning space, ranking of the artifacts and assets ranking increases.

The authorized users of community portal can view their learning spaces network they are linked with, their friends network they are connected with, the past activities and contributions in the learning spaces and their ranking progress. The owner of the learning space can add tools such as blog, Wiki, RSS, Podcast, discussion forum and other available collaboration tools available in the community portal. The metadata provided by said authorized user of community portal can be organization, role, name, email, date of birth, gender, address, country, state, city, contact number, interest, education, competencies, and keywords.

The users of the learning space can create/contribute on blogs by posting information or opinion, comments, viewing and rating. The users of the learning space can create/contribute on Wiki pages by editing contents or watching the content development. The users of the learning space can subscribe RSS feeds and get updated information instantly. The users of the learning space can subscribe Podcast of audio/video materials related to course contents or any interested topics. The users of the learning space can participate in discussion forum by posting topics, replies and rating topics/replies. The users of the learning space can collaborate with the other learning Space members using collaboration tools such as text chat, audio/video conferencing, whiteboard and presentation.

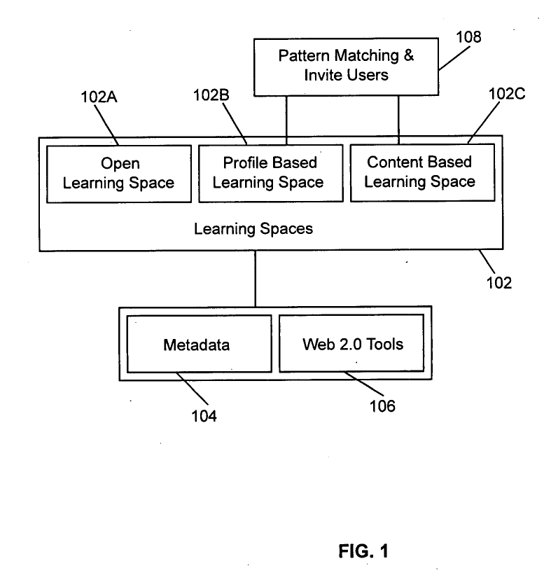

FIG. 1 shows three types of learning spaces 102. Learning spaces 102 are personalized user interaction spaces providing a pathway to access enterprise contents, services and processes. All Web 2.0 services 106 and collaboration services come together as part of learning spaces. Three types of learning spaces that can be created are: Open learning space 102A; Profile based learning space 102B; Content based learning space 102C. Open learning spaces 102A are open to all the users of community portal. Interested users can register and become member of the learning spaces. In these types of learning spaces, learning space profile may be common interest for the users. For e.g. it could be current events, sports. All the three types of learning spaces are attached with learning space metadata 104 and Web 2.0 tools 106. In case of content based learning space 102C, content are mapped to the learning space. There can be any number of learning spaces (virtual spaces) where users can interact and collaborate. Only authenticated/authorized users have entries to the system.

Authorized users can create learning spaces based on their privileges. Once the learning space is created, the creator becomes owner of the learning space. The owner of the learning space can set the Web 2.0 tools privileges to the members of that learning space. Owner of the learning space himself is a moderator of the learning space; he can assign moderator privileges to one or more members of the learning space. In profile based learning spaces 102B in-depth collaboration is required e.g. it could be a secondary school Mathematics, Newton's third Law. Users are invited to the learning spaces based on pattern match and search 108. The matching is based on learning space profile with users' profile. Based on the search results, the creator of learning space can shortlist compatible profiles and send invites to the user to join the learning space. The advantage of this type of learning space is that the member's profiles are similar with the learning space profile and they can add more value to the discussions and collaborations.

In content based learning spaces 102C, profile of the learning spaces may be any content or course content. For e.g. it could be a course content of software engineering, metamorphosis etc. Like profile based Learning Space 102B, users' are invited through pattern match and search 108 by matching users profile with learning space profile. The creator of the learning space can import and map the content to the learning space and the members of the learning space are can access the same.

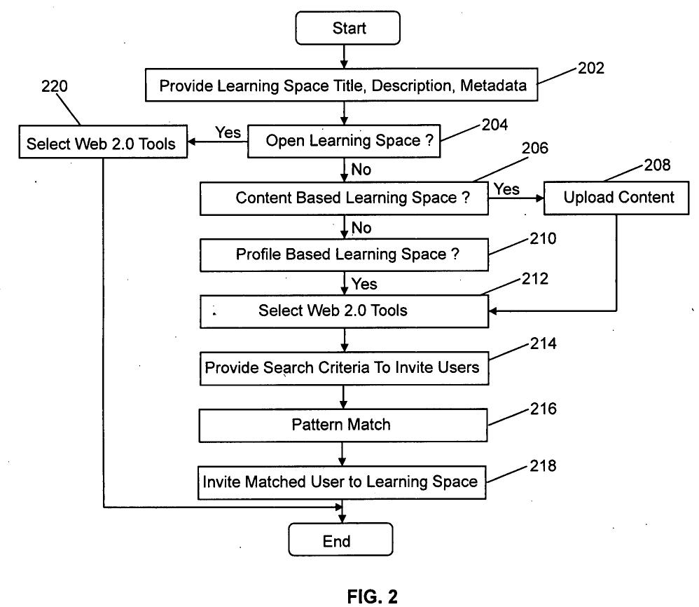

FIG. 2 illustrates flowchart for creation of learning space. Creator of the learning space can provide the following details about the learning space (202): learning space type like (open learning space, profile based learning space, content based learning space); title of the learning space; description; language; keywords; image for the learning space. User/creater confirms whether the type of learning space selected is open learning space (204). In case of open learning space, the process of learning space creation (204) gets completed in step (220) once the Web 2.0 tools are attached with the learning space. In case of content based learning space (206), user can select and map the SCORM (Sharable Content Object) content or any learning Objects to the learning space 208. If SCORM content is mapped, some of learning space profile data is inherited from the tagged content metadata such as: topic in scope; topic out of scope; prerequisites; learning objectives; prior learning; skills; age range; country; educational level; learning space duration etc. The creator of the learning space can add tools to the learning space (212) such as blog, Wiki, RSS, Podcast, discussion forum, collaboration tools. The creator can also set the user accessibility for the tools; set dates to “Go Live” (start date) and the expiry date (end date) for the tools. In case of Profile based learning space (210) or content based learning space (206), the creator can provide search criteria to invite the user (214). The system can automatically match the pattern and display the matched user (216). Owner can select the users to be invited for the learning space (218).

In order to become member of community portal, interested users can register themselves through the portal. Registered users are approved/rejected by administrator. Registered users receive confirmation of registration through e-mail. User provides the information during the registration along with additional keywords. User information consists of user's metadata, which is part of the LIP (Learner Information Package). Administrator manages the users, roles, organizations, learning spaces and settings. Administrator creates roles and assigns privileges to the role. Administrator assigns role/privileges to the users. Authorized users (teachers) can create and invite members to the learning space. Members including owner of the learning spaces can create and contribute to learning space artifacts and assets.

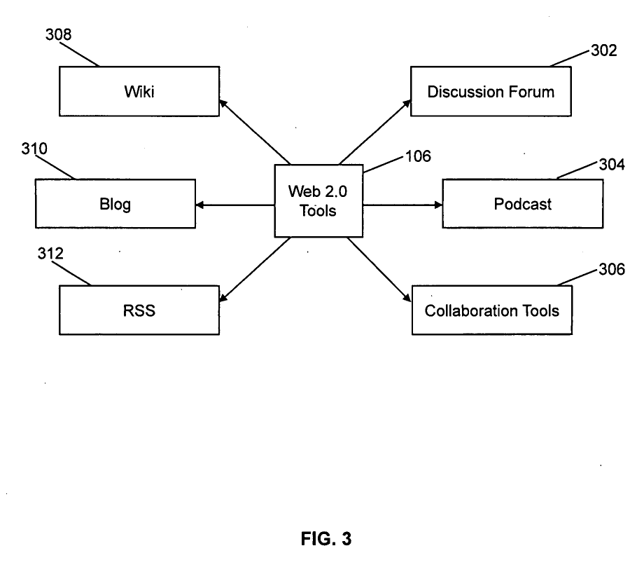

FIG. 3 shows WEB 2.0 tools associated with a leaning space. The community portal provides rich sets of Web 2.0 tools 106 to increase interactions and knowledge sharing among learning space members. Based on their Web 2.0 privileges, the learning space members can create, contribute and rate artifacts/assets. The following Web 2.0 tools are provided: blog 310; Wiki 308; Podcast 304; RSS 312; discussion forum 302; collaboration tools 306.

Discussion forum 302 is an online service that allows registered users to post questions and responses to posted questions or exchange ideas, offer answers, offer help on relevant subjects. This provides for discussion, often in conjunction with online communities and also provides ways of archiving and searching for previous exchanges. Authorized learning space members can post/view/reply topics in the discussion forum. Topics can be categorized with category and sub category. All the posts and Comments can be moderated (based on the moderation required setting option). Members of the learning space can rate the topics.

Podcast 304 is a collection of files (usually audio and video) residing at a unique web feed address. Learning communities can “subscribe” to this feed by submitting the feed address. When new “episodes” become available in the podcast they are automatically downloaded to that user's computer. Podcasts with audio recordings of talks, interviews and lectures are usually in MP3 format, which can be played either on a desktop computer or on a wide range of handheld MP3 devices. Learning space members can add/view/remove Podcast. Members can add new Podcast or add as episode to the RSS feed by entering the RSS URL or manually upload audio/video files. Learning space members can comment and view the Podcast. Podcast can be categorized with category and sub category. Podcast personalization features such as learning space Podcast and recent Podcast are available. Members can personalize their Podcast with features like My Podcasts, Tag clouds, Top Podcasts and set the featured Podcasts. Members are allowed to rank the Podcast.

Collaboration tools 306 aids in creating a collaborative real-time environment that provides links to variety of tools such as whiteboard, presentation, text chat, audio and video conferencing. Collaboration tool offers active learning by means of interaction and communication between the members of learning spaces. Options are available to schedule collaboration tools 306 and invite learning space members for collaboration.

Wiki 308 is a webpage or set of web pages that can be easily edited by anyone with allowed access. The concept of the Wiki 308 is a collaborative tool that facilitates the production of a group work. Wiki 308 generally have a history functions, which allows previous version to be examined and rollback function, which restores previous versions. Wiki pages have an edit button displayed on the screen and the user can click on this to access an easy-to-use online editing tool to change or even delete the content of the page in question. Authorized learning space members can create/edit/view a Wiki. Wiki category and sub-category is assigned by owner of the learning space or authorized user. All the Wiki edits can be moderated (based on the moderation required setting). Authorized members can view Wiki page history and watch Wiki page edits.

Blog 310 refers to a simple webpage consisting of brief paragraphs of opinion, information, personal diary entries, or links called posts, arranged chronologically with the most recent first, in the style of an online journal. Blogs 310 allow visitors to add a comment below a blog entry. A typical blog 310 combines text, images, and links to other blogs, web pages, and other media related to its topic. The ability for readers to leave comments in an interactive format is an important part of blog 310. Authorized learning space members can create/edit/view blogs 310 and post information and comments. All the posts and comments will be moderated by moderator (based on the moderation required setting). Members of the learning space can rate the post as well as blog. Feature available to archive the blog posts.

RSS 312 means “Really Simple Syndication” which allows users to find out updates to the content of RSS-enabled websites, blogs or podcasts without actually having to go and visit the site. Instead, information from the website (typically, a new story's title and synopsis, along with the originating website's name) is collected within a feed (which uses the RSS format) and ‘piped’ to the user in a process known as syndication. RSS serves the subscribed members with frequently updated content into their learning space portal. Authorized learning space members can add/edit/view/remove RSS feeds. Members can add feeds by specifying the blog or feed URL. Options are available to organize RSS feeds into folders. RSS feeds can be clipped and read later. RSS feeds can also be labeled or tagged as “Mark as Read” for reference. RSS feeds can be imported/exported into OPML format. Feature available SLS news feeds, which updates latest News. Members can unsubscribe or delete the feeds to stop receiving the updates.

Learning spaces provide platform for interaction and knowledge sharing among the similar profiled learning space members. Learning space members can create, contribute and rate artifacts/assets in connection with the objectives of the learning space and start interacting with other learning space members. [0051] Learning space members can manage artifacts and collaboration. They can create/contribute on blogs 310 by posting information or opinion, comments, viewing and rating. Members can create/contribute on Wiki 308 pages by editing contents or watching the content development. Members can subscribe RSS Feeds 312 and get updated information instantly. Members can subscribe Podcast 304 of audio/video materials related to course contents or any interested topics. Members can participate in discussion forum 302 by posting topics, replies and rating topics/replies. Members can collaborate with other learning space members using collaboration tools 306 such as text chat, audio/video conferencing, whiteboard and presentation for knowledge sharing. Learner ranking is used to rank the users of the learning space. Whenever a user adds some value to the system, e.g. create, contribute, rate an artifact/asset he gets some points.

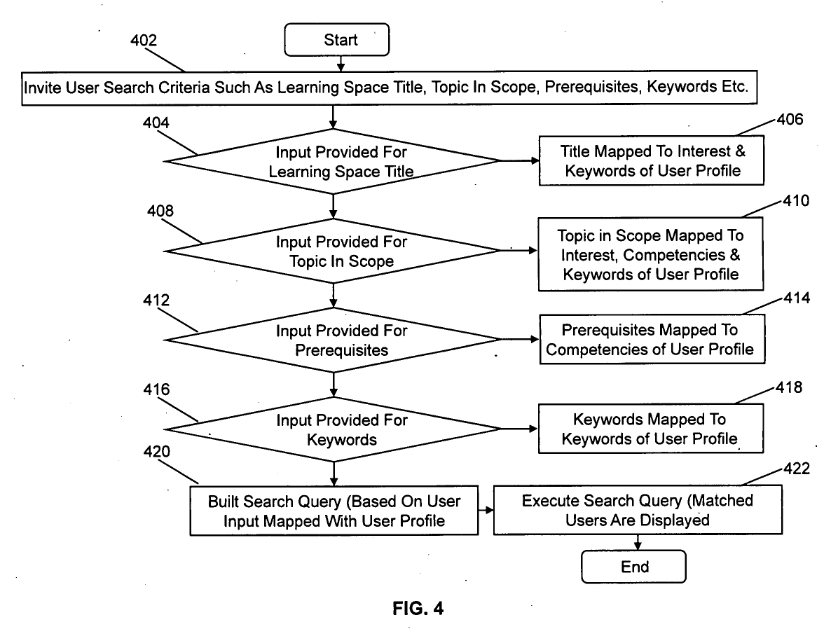

FIG. 4 shows flowchart of search engine functionalities. The portal has inbuilt intelligence of pattern matching and search which helps in the process of finding as many members' profile that are matched with learning space profile. This feature establishes meaningful communication and collaboration among the learning space members. Also, user can select required search criteria (metadata) for pattern matching and search. Once the pattern is matched, the search results are displayed. To invite users to learning space, the owner of the learning space can provide the required pattern match search criteria (metadata) (402) such as learning space title, topic in scope, prerequisites, skills, education level, age range, language, region and keywords. If learning space title is entered as search criteria (404), learning space title is mapped to interest and keywords of user profile (406). If learning space topic in scope is entered as search criteria (408), topic in scope is mapped to interest, competencies and keywords of user profile (410). If learning space prerequisites is entered as search criteria (412), prerequisites are mapped to competencies of user profile (414). If learning space education level is entered as search criteria, education level is mapped to education level of user profile. If learning space age range is entered as search criteria, age range is mapped to data of birth of user profile. If learning space region is entered as search criteria, region is mapped to the country of user profile. If learning space keywords is entered as search criteria (416), keywords are mapped to keywords of user profile (418). Search query is built based on the above search criteria entered (420) and executed and matched user profiles are displayed (422).

Learner ranking system encourages learning space members' contribution on artifacts/assets by providing points. The ranking engine automatically calculates points for all contributions and adds the same to learning space members and artifacts. The user can contribute on self and other artifacts/assets such as blog, discussion forum, and podcast. Learner ranking feature helps to identify learning space top rankers and artifacts based on the contribution and rating received. Also, it helps learning space members to interact with other members who are ranked higher and probably get a chance to improve their understanding of the learning space topics. Ranking configuration is used to configure ranking points. It consists of three parts: a) rating to artifact/asset; b) points to user activities; c) user levels. Rating to artifacts /assets option is used to configure points and remark for all the levels of artifacts. Points are awarded: on rating to others artifacts/assets; when unique or new visitors visits to artifacts; on contribution to asset; on contribution to others asset; on tagging metadata (keywords) to artifact/asset; when artifact is chosen as featured etc. User Levels option specifies user level based on the points earned. For e.g. based in points user title can be active member, contributor, performer, expert etc.

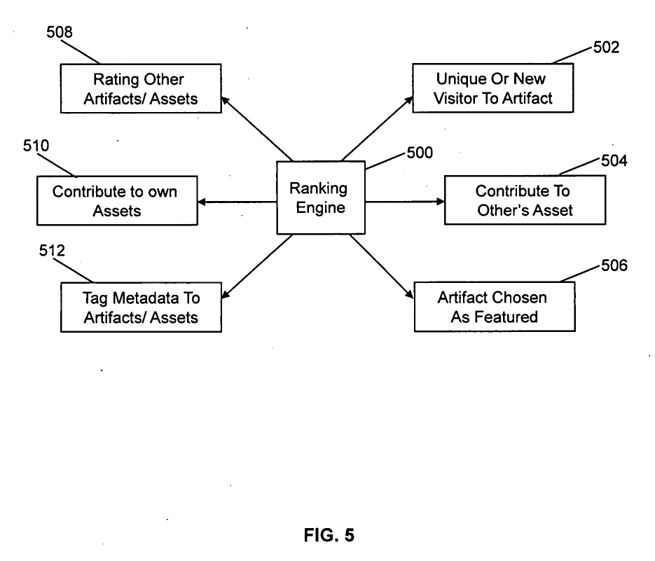

FIG. 5 illustrates ranking engine modules. Ranking engine 500 can calculate points based on rating configuration and rating calculation table. Points are picked and added based on ranking configuration and ranking calculation table, points are calculated for member, artifact and owner of the artifact/asset. Internally, ranking engine calculates ranking in six ways: when a member performs rating to other's artifact/asset, points are added to the member, to the contributed artifact and to the owner of the artifact (508); when a member visited as Unique or new visitors to artifact, points are added to visited artifact and to the owner of the artifact (502); when a member contribute to own asset, points are added to the member and to the contributed artifact (510); when a member contribute to other's asset, points are added to the member, contributed artifact and owner of the artifact (504); when a member tags metadata (keywords) to an artifact, points are added to owner of the artifact (512); when an artifact is chosen as feature, points are added to owner of the artifact (506).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of providing online community portal to improve communication and collaboration among authorized users of a wide range of learning communities of the portal and further presenting and sharing the information from diverse sources in a unified way. The method comprising:
collecting and storing information about authorized user of said community portal in form of metadata;
creating collaborative learning space by said authorized user based on the preference and administrative privileges provided to said user, wherein metadata is attached to each said learning spaces;
providing the compendium of Web tools such as Blog, Wiki, RSS Feeds, discussion forum, Podcast and other collaboration tools for said learning space;
using metadata to invite similar profile users to said learning space through automatic pattern match and search, wherein said pattern match and search is conducted between metadata of said learning space and metadata of said authorized users; and
building information space by contributing contents, posting views/queries and comments, rating artifacts, subscribing news and audio/video materials in the said learning space by user's of said learning space; wherein each user's privileges are decided by creator of the learning space.

2. The method of claim 1, wherein said learning spaces are information spaces for communication and collaboration among users with compatible profiles for the said learning spaces.

3. The method of claim 1, wherein authorized user of said learning space can interact, communicate, collaborate, co-ordination and share the knowledge and data with other users of said learning space.

4. The method of claim 1, wherein said pattern match and search can be conducted automatically or manually.

5. The method of claim 4, wherein owner of said learning space has to provide search criteria for said manual pattern match and search.

6. The method of claim 1, wherein creator of said learning space becomes owner of learning space.

7. The method of claim 1, wherein the owner of said learning Space can upload and share documents with other users of said learning space.

8. The method of claim 1, wherein said user of said learning space can upload and share documents with other users of said learning space based on privileges provided to said user by said owner of said learning space.

9. The method of claim 1, wherein said learning space is content based learning space.

10. The method of claim 9, wherein said content based learning space is created based on specific content uploaded on said learning space by said owner and further discussions on the same.

11. The method of claim 9, wherein said owner of said content based learning space has the authority to invite similar profile users to said learning space based on said pattern match and search.

12. The method of claim 1, wherein said learning space is open learning space.

13. The method of claim 12, wherein any authorized user of said community portal can join said learning space.

14. The method of claims 12, wherein said open learning space can be created for any general topic/subject/process.

15. The method of claim 1, wherein said learning space is profile based learning space.

16. The method of claim 15, wherein said profile based learning space is created based on specific topic/subject/process.

17. The method of claim 15, owner of said profile based learning space has the authority to invite similar profile users to said learning space based on said pattern match and search.

18. The method of claim 1, wherein said owner of learning space provides metadata related to the learning space such topic in scope, topic out of scope, prerequisites, learning objectives, prior learning, skills, preference, age range, country, educational level, other keywords.

19. The method of claim 1, wherein learner ranking is used to rank said users of the learning space.

20. The method of claim 19, wherein said user gains some points based on predefined formula whenever said user adds some value to the learning space by creating an artifact inform of blog, wiki, discussion forum topic; by contributing to any blog post, Wiki, discussions of the learning space, tagging metadata to any artifact or asset of the learning space.

21. The method of claim 19, wherein said learner ranking feature helps to identify the learning space top rankers and artifacts based on the contribution and rating received and further provides other users of the learning space an opportunity to interact with top rankers and get a chance to improve their understanding of the learning space topics.

22. The method of claim 1, wherein the authorized users of community portal can view their learning spaces network they are linked with, their friends network they are connected with, the past activities and contributions in the learning spaces and their ranking progress.

23. The method of claim 1, wherein owner of said learning space can add tools such as blog, Wiki, RSS, Podcast, discussion forum and other available collaboration tools available in said community portal.

24. The method of claim 1, wherein said the metadata provided by said authorized user of community portal can be organization, role, name, email, date of birth, gender, address, country, state, city, contact number, interest, education, competencies, keywords.

25. The method of claim 1, wherein said users of the learning space can create/contribute on blogs by posting information or opinion, comments, viewing and rating.

26. The method of claim 1, wherein said users of the learning space can create/contribute on Wiki pages by editing contents or watching the content development.

27. The method of claim 1, wherein said users of the learning space can subscribe RSS feeds and get updated information instantly.

28. The method of claim 1, wherein said users of the learning space can subscribe Podcast of audio/video materials related to course contents or any interested topics.

29. The method of claim 1, wherein said users of the learning space can participate in discussion forum by posting topics, replies and rating topics/replies.

30. The method of claim 1, wherein said users of the learning space can collaborate with the other learning space members using collaboration tools such as text chat, audio/video conferencing, whiteboard and presentation.

31. The method of claim 1, wherein based on contribution on artifacts and assets by said users of said learning space, ranking of said artifacts and assets ranking increases.
